(19) United States
(12) Patent Application Publication
(10) Pub. No.: US 2017/0328384 A1
(43) Pub. Date: Nov. 16, 2017

(54) ACTUATOR, ACTUATOR SYSTEM, AND CHANNEL COMPONENT

(71) Applicant: Kabushiki Kaisha Toshiba, Minato-ku (JP)

(72) Inventors: Tatsuhiko GOTO, Kawasaki (JP); Junichiro OOGA, Kawasaki (JP)

(73) Assignee: Kabushiki Kaisha Toshiba, Minato-ku (JP)

(21) Appl. No.: 15/442,923

(22) Filed: Feb. 27, 2017

(30) Foreign Application Priority Data
May 13, 2016 (JP) 2016-096976

(51) Int. Cl. F15B 15/10; F15B 11/16

(52) U.S. Cl. CPC F15B 15/103; F15B 11/16; F15B 2211/7142; F15B 2211/40

(57) ABSTRACT

According to one embodiment, an actuator includes a plurality of channel members each having at least one first port into which fluid flows and at least one second port from which the fluid flows out. At least one of the channel members includes a different number of second ports from a number of first ports. The channel members are joined with each other to form at least one channel component.

### CROSS-REFERENCE TO RELATED APPLICATIONS

This application is based upon and claims the benefit of priority from Japanese Patent Application No. 2016-096976, filed on May 13, 2016; the entire contents of which are incorporated herein by reference.

### FIELD

Embodiments described herein relate generally to an actuator, an actuator system, and a channel component.

### BACKGROUND

Conventional artificial muscles are often used in the fields of power assist or industrial robots, and artificial muscles with large diameters such as McKibben muscles are generally used.

Artificial muscles with smaller diameters ranging from 1.3 millimeters to 4 millimeters have been developed in recent years, and their applications to biomimesis and power-assisted suits are promising.

Use of such artificial muscles having small diameters improves the freedom of installation, compared with motor-driven counterparts. It is expected that such artificial muscles will enable the manufacture of a super-multi-degree-of-freedom hand that is capable of mimicking every muscle, which is not typically achieved. Furthermore, because the artificial muscles are made of flexible materials, entirely light and soft devices can be manufactured. This will help attain light-weighted devices compatible with people.

Currently, such artificial muscles are controlled by a method in which the same pressure is applied to muscle fibers forming artificial muscles to equally expand and contract the muscle fibers. With this method, however, the pressure applied to the muscle fibers cannot be incrementally changed, therefore, it is difficult to mimic the complex movement of muscles, such as those of hands.

An object of the present invention is to provide an actuator including a group of actuator elements and capable of selectively operate actuator elements so as to incrementally change the contraction generated by the entire actuator element group.

### BRIEF DESCRIPTION OF THE DRAWINGS

FIG. 1 is a schematic of an actuator according to a first embodiment;

FIG. 2 illustrates the numbers of actuator elements to be driven by combinations of ON/OFF states of switching valves, and their respective output values;

FIG. 3 is a schematic of an actuator according to a second embodiment;

FIG. 4 illustrates the numbers of the actuator elements to be driven by combinations of ON/OFF states of switching valves, and their respective output values;

FIG. 5 is a schematic illustrating multiple channel members each having a cuboid shape;

FIG. 6 is a schematic illustrating an example of a channel component including the channel members arranged in a spiral form;

FIG. 7 is a schematic illustrating an example of a channel component including the channel members arranged in a ring-like form;

FIG. 8 is a schematic illustrating a channel component including the channel members of a cylindrical shape each having a first port and second ports on the side face;

FIG. 9 is a schematic illustrating a channel component of a hexagonal-columnar shape joined with three channel members;

FIG. 10 is a schematic illustrating a modification of the channel component illustrated in FIG. 9;

FIG. 11 is a schematic illustrating an example of the arrangement of three channel components, as illustrated in FIG. 9 or 10, adjacent to one another;

FIG. 12 is a schematic illustrating an example of the serial arrangement of the channel components, as illustrated in FIG. 9 or 10, adjacent to one another;

FIG. 13 is a schematic of an actuator according to a fourth embodiment;

FIG. 14 is a schematic illustrating an example of an arrangement of an actuator element group connected to a channel block;

FIG. 15 is a schematic illustrating an actuator according to a fifth embodiment;

FIG. 16 is a schematic illustrating an example of a configuration of a fluid supply part in a first driving method;

FIG. 17 is a schematic illustrating an example of a configuration of a fluid supply part in a second driving method;

FIG. 18 is a schematic illustrating the amounts of change in a driving angle when the number of the actuator element is seven; and

FIG. 19 is a schematic illustrating an example of a configuration of a fluid supply part in a third driving method.

### DETAILED DESCRIPTION

In general, according to one embodiment, an actuator includes a plurality of channel members each having at least one first port into which fluid flows and at least one second port from which the fluid flows out. At least one of the channel members includes a different number of second ports from a number of first ports. The channel members are joined with each other to form at least one channel component.

In general, according to one embodiment, an actuator system includes the actuators, a fluid supply source that supplies fluid, a control valve configured to control a flow rate of the fluid from the fluid supply source, and a plurality of switching valves configured to switch supply and non-supply of the fluid from the control valve to the channel members.

In general, according to one embodiment, a channel component for use in an actuator that operates when supplied with fluid includes a plurality of channel members each including a first port from which the fluid flows and a second port from which the fluid flows out. At least one of the channel members includes a different number of second ports from a number of first ports. The channel members are joined with each other.

An actuator and a channel component according to embodiments will now be explained with reference to the accompanying drawings.

The drawings are schematic and conceptual representations, and relations between thickness and width of parts or ratios between sizes of such parts do not necessarily represent actual sizes. Same parts may be represented in different sizes or at different ratios among the drawings. Hereinafter, elements having the same or similar functions are given the same reference numerals, and redundant explanations of such elements may be omitted.

### First Embodiment

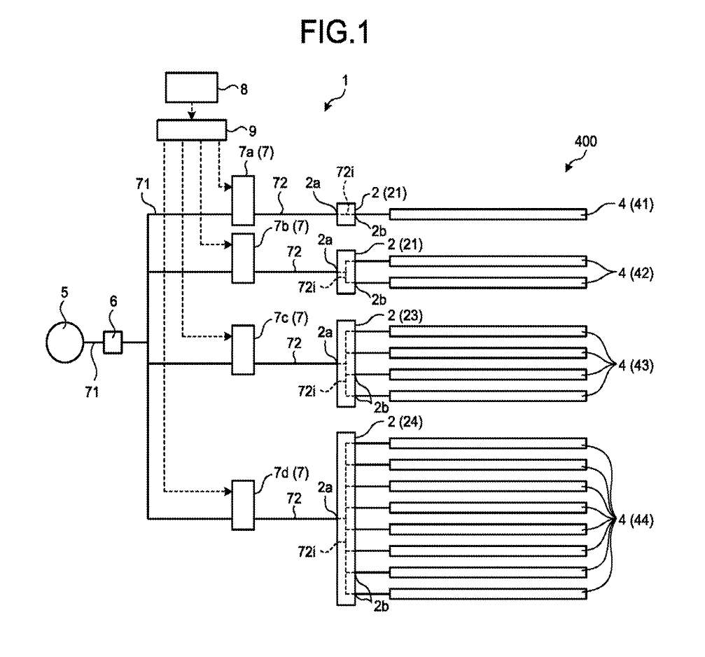

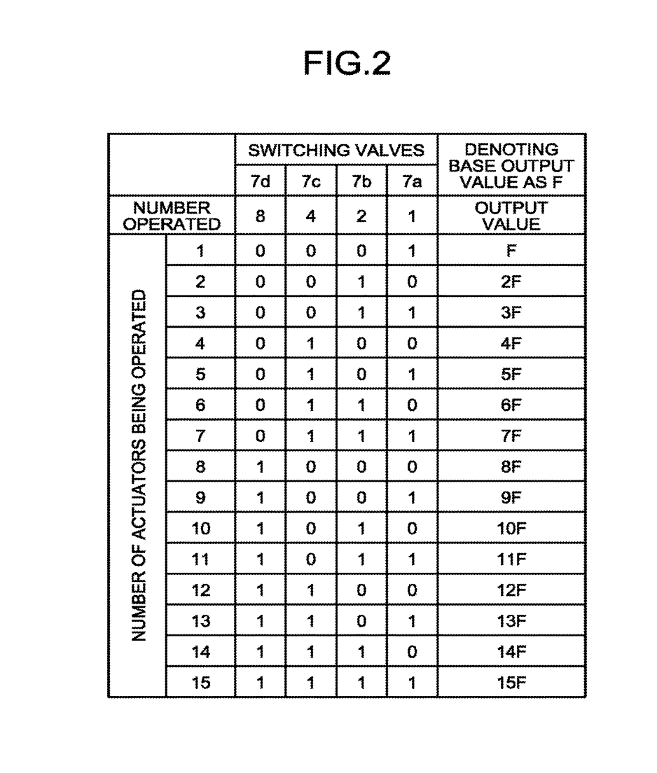

An actuator 1 according to a first embodiment will now be explained with reference to FIGS. 1 and 2.

FIG. 1 is a schematic of the actuator 1. As illustrated in FIG. 1, the actuator 1 includes multiple channel members 2. A structure including the channel members 2 is referred to as a channel component 3.

Each of the channel members 2 includes a first port 2a into which fluid flows, and multiple second ports 2b from which the fluid flows out. The first port 2a is connected to the second ports 2b inside the channel member 2.

To the second ports 2b of the corresponding channel member 2, actuator elements 4 are connected in parallel set of at least one or more actuator elements 4 connected to the second ports 2b of the channel member 2 is referred to as an actuator unit 40 (41 to 44). The actuator elements 4 connected to the respective second ports 2b of the channel component 3 are referred to as an actuator element group 400.

The fluid flows out from the channel member 2 and flows into the corresponding actuator element 4. The actuator element 4 is placed in an operating state to generate a predetermined output value when supplied with the fluid, and is placed in a non-supplied state when the fluid supply is stopped or the fluid is discharged. The actuator element 4 has a tube-like shape, and is made of a material that expands and contracts in response to an increase in the internal pressure. For example, along with the fluid supply, the actuator element 4 expands radially side direction) and contracts axially, and generates a tensile force (contraction) which pulls both axial ends (operating state). By contrast, during the non-supplied state in which the fluid is discharged, the actuator element 4 contracts radially and becomes stretched axially due to the elastic force of the tube, for example, and recovers its original shape (non-operating state). The value output from the actuator element 4 represents a tensile force (contraction), for example.

As illustrated in FIG. 1, the actuator elements 4 are arranged in parallel. In the actuator 1, the output value from the actuator element group 400 is chanced by switching the number of the actuator elements 4 operating concurrently. The actuator 1 according to the present embodiment switches the operating state and the non-operating state of each of the actuator elements 4 to switch the output values of the actuator element group 400.

The actuator 1 includes a fluid supply source 5, a pressure control valve 6, and switching valves 7, as a mechanism for supplying the fluid to the channel component 3 and the actuator elements 4.

As illustrated in FIG. 1, the fluid supply source 5 is connected to the pressure control valve 6 via a channel 71. The pressure control valve 6 is connected to the switching valves 7 via the channel 71. The switching valves 7 are connected to the first ports 2a of the channel member 2 via channels 72, respectively. The number of switching valves 7 is the same as that of the channel members 2. In FIG. 1, the numbers of the channel members 2 (21 to 24) and the switching valves 7 (7a to 7d) are both four. This is intended for controlling the fluid supply in units of the channel member. In other words, this is for controlling the output value of each of the actuator units 40.

The fluid supply source 5 supplies the fluid to the channel component 3 and the actuator elements 4. Examples of the fluid supply source 5 include a pump, a high-pressure tank, a gas cylinder, an accumulator, and a compressor. A tank, a reservoir, or a drain pan may be provided upstream of the fluid supply source 5. The fluid is preferably air, but may also be gas, or a liquid such as water or oil.

The pressure control valve 6 controls the pressure of the fluid to be supplied into the channel component 3 and to the actuator elements 4. The pressure control valve 6 can maintain the fluid at about a predetermined pressure. Examples of the pressure control valve 6 include a relief valve, a reducing valve, a sequence valve, a counterbalance valve, and an unloader valve. The pressure control valve 6 may also be referred to as a control valve.

The switching valves 7 are solenoid valves capable of switching the opening and closing of channels and the connections among the channels, in response to electric signals. The switching valves 7 thereby controls the fluid supply to the channel members 2. Each of the switching valves 7 is a three-wave solenoid valve provided with three ports (not illustrated) including a supply port, an actuator port, and a discharge port (return port), for example. In this example, the supply port is connected to the channel 71 controlled in pressure. The actuator port is connected to the channel 72 which leads to the actuator element(s) 4, and the discharge port is connected to a drain (low-pressure channel). Each of the switching valves 7 switches, in response o an electric signal, between a first state in which the actuator port becomes connected with the supply port and disconnected from the discharge port, and a second state in which the actuator port becomes connected with the discharge port and disconnected from the supply port. In the first state, the actuator elements 4 become connected via the channels 72 and the switching valve 7 to the pressure-controlled channel 71 by the pressure control valve 6 (high-pressure channel) The fluid is thus supplied into the actuator elements 4. In the second state, the actuator elements 4 become connected with the drain via the channels 72 and the switching valves 7, and disconnected from the channel 71. The fluid is not supplied to the actuator elements 4 and discharged from the actuator elements 4. In other words, by switching the first state and the second state of each of the switching valves 7, the supply state and non-supply state of the fluid to the actuator elements 4 or the operating state and non-operating state of the actuator elements 4 are switched. Hereunder, the first state is referred to as an ON state, and the second state is referred to as an OFF state. The configurations of the switching valves 7 and the channels 71 and 72 are not limited to the examples described herein.

Structures of the channel members 2, the actuator elements 4, and the switching valves 7 will how be explained in detail.

Each of the channel members 2 according to the embodiment has a different number of the second ports 2b. As illustrated in FIG. 1, the four channel members 2 have different numbers of second ports 2b, one, two, four, and eight, respectively. To simplify, the number of the channel members 2 (21 to 24) is set to four, but it may be more than four. For example, where the number of the channel members 2 is n, the number of the second ports will be 2ⁱ where i is an integer equal to or more than 0 and equal to or less than n-1. Preferably, a single first port 2a is provided to each of the channel members 2.

Each of the channel members includes a channel 72i inside. The channel 72i is at least a part of the channel 72 extending between the corresponding switching valve 7 and one or more actuator elements 4. The channel 72i extends from the first port 2a, is internally branched, and connected to the second ports 2b.

One ends of the actuator elements 4 are connected in parallel to the respective second ports 2b.

As illustrated in FIG. 1, the numbers of the actuator elements 4 connected to the respective channel members 2 are one, two, four, and eight, respectively. When all of the actuator elements 4 provide the same output value under the same condition, e.g., having the same specifications, the output value from the actuator unit 40 including the actuator elements 4 or the output value from the actuator element group 400 will be a product of the number of the actuator elements 4 in operation (operating number) multiplied by the output value of one actuator element 4. In other words, the output value of two actuator elements 4 when operating in parallel will be twice the output value of one actuator element 4 operating alone. When n actuator elements 4 (where n is an integer) are in operation in parallel, the resultant output value will be a product of the output value of the actuator element 4 operating alone multiplied by n.

In FIG. 1, when the actuator unit 41 including one actuator element 4 serves as a reference for the output value, the output values from the actuator units 42 to 44 will be twice, four times, and eight times the output value from the actuator unit 41, respectively. Hereinafter, the output value of the actuator elements 4 will be referred to as a base output value.

The fluid supply to the actuator elements 4 is controlled by the switching valves 7 connected to the respective channel members 2.

Each of the switching valves 7 opens and closes the valve connected to the channel member 2 to supply or not supply the fluid into the corresponding channel member by the. In other words, the switching valves 7 sets supply or non-supply of the fluid for each actuator unit. As illustrated in FIG. 1, the switching valves 7a to 7d are connected to the respective channel members 21 to 24.

In FIG. 1, the number of the actuator elements 4 operated by the ON state of the switching valve 7a is one. The number of the actuator elements 4 operated by the ON state of the switching valve 7b is two. The number of the actuator elements 4 operated by the ON state of the switching valve 7c is four, and the number of the actuator elements 4 operated by the ON state of the switching valve 7d is eight.

The table in FIG. 2 lists the numbers of the actuator elements driven by combinations of the ON state and the OFF state of the switching valves 7a to 7d, and their respective output values. In the table, the ON state is denoted by 1, and the OFF state is denoted by 0. The ON/OFF states have 15 patterns of (0001) to (1111). By the operations of the switching valves 7, the number of the actuator elements 4 to be driven can be changed from one to 15 one by one. In other words, the output value from the actuator element group 400 can be switched in increments of one from a factor of 1 (base output value) to 15.

The same applies when the number of the channel members 2 is more than four. For example, if the number of the channel members 2 and the switching valves 7 is n, the number of valve ON/OFF patterns will be (2ⁿ-1). By the operation of the switching valves 7, the number of the actuator elements 4 to be driven can be changed from one to (2ⁿ-1), and the output value from the actuator element group 400 can be switched in increments of one from a factor of 1 (base output value) to (2ⁿ-1).

It will be understood that every decimal number can be represented by switching each digit (each bit) of the binary between 0 and 1, enabling this control.

The actuator 1 includes a control unit 8 and a driving circuit 9, serving as a control system for inputting a control signal (an electric signal) to the switching valves 7. The control unit 8 generates a command signal to the driving circuit 9 based on a detection result of a sensor (not illustrated), on a command received from an external device (not illustrated), or on operation inputs by an operator to an operation unit (not illustrated). The control unit 8 is a computer such as an electronic control unit (ECU), for example. The control unit 8 may include a controller, a main memory, and an auxiliary memory. The controller can implement the functions of the control unit 8 by executing calculations according to a computer program (application, software) installed therein. At least part of the functions of the control unit 8 may be implemented as hardware such as an application specific integrated circuit (ASIC), a field-programmable gate array (FPGA), or a digital signal processor (DSP).

The driving circuit 9 receives a command signal from the control unit 8, and outputs a control signal (electric signal) for switching the status of each of the switching valves 7 in response to the command signal. The driving circuit 9 includes a power supply circuit and switching elements, for example, and switches the opening and closing of the switching elements in accordance with the command signal to output a control signal for causing a driver of the switching valves 7 to operate.

In this embodiment, the fluid supply to the actuator element group 400 can be finely controlled by the switching valves 7 separately attached to the respective channel members 2.

Each of the actuator elements 4 is a McKibben artificial muscle, for example, the actuator units 40 thus contract in response to the supplies of the fluid. The output value thereof represents a tensile force generated from the contraction of the actuator units 40. That is, the actuator 1 according to the embodiment is applicable to an artificial muscle system. According to this embodiment, each of the actuator elements 4 can function as a muscle fiber with a relatively small diameter, and the actuator element group 400 can function as a muscle fiber group, that is, an artificial muscle that mimics a bundle of muscles.

### Modification of First Embodiment

An actuator 1 according to a modification of the first embodiment will now be explained.

In the first embodiment, the output value from the actuator element group 400 can be changed in increments of one (base output value), by setting a power of two as the number of the actuator elements 4 in one actuator unit.

This modification describes a configuration in which the number of the actuator elements 4 in one actuator unit is not a power of two. The rest of the configuration is the same as that of the actuator according to the first embodiment.

Assume that there are six channel members 2 connected to the channel members 2, forming actuator units 41 to 46. The numbers of the actuator elements 4 in the actuator units 41, 42, and 43 are set to one, two, and three, respectively. In this case, the actuator units 44, 45, and 46 include seven, fourteen, and twenty-eight actuator elements 4, respectively.

By setting the numbers of the actuator elements 4 of the respective actuator units 41 to 46 as described above, the switching valves 7 can be switched ON and OFF to change the output value from the actuator element group 400 in increments of one from a factor of 1 (base output value) to 55.

To generalize, where the number of the actuator units is i =1, 2, 3, . . . , m, and the number of the actuator elements is P(i)=1, 2, 3, . . . , m, the number of the actuator elements P(i) equal to or more than i will be expressed as Equation (1) below.

ti P(i)=(Σ(j)+1)·2^{i-m-1)}

where j=1,2 . . . , m

Thereby, if m=3, for example, P(i) will be 1, 2, 3, 7, 14, 28, 56, . . . . If m=4, as another example, P(i) will be 1, 2, 3, 4, 11, 22, 44, . . . .

By the above configuration, the output value from the actuator element group 400 can be changed in increments of one (base output value), even without setting the number of the actuator elements 4 to a power of two.

### Second Embodiment

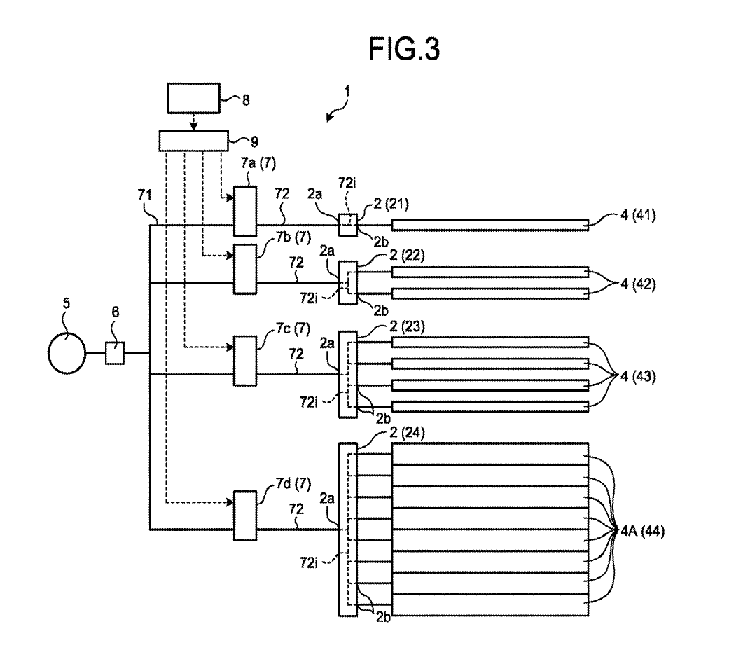

An actuator 1 according to a second embodiment will now be explained with reference to FIG. 3.

In this embodiment, the actuator elements 4 include actuator elements 4A with different diameters. The rest of the configuration is the same as that of the actuator according to the first embodiment. In this embodiment, the diameter of the actuator element 4A is set to provide the output value twice the base output value from the actuator element 4. For example, to obtain the output value twice the base output value, the diameter is set to about √2 times larger, assuming that the artificial-muscle lengths and the sleeve-winding angles of the actuator elements 4 and the actuator elements 4A are the same. In FIG. 3, the actuator elements 4A are connected to all of the second ports 2b provided to the channel member 24.

The actuator elements 4A may be applied to each of the channel members 2, or used as part of the actuator elements connected to the channel members 2.

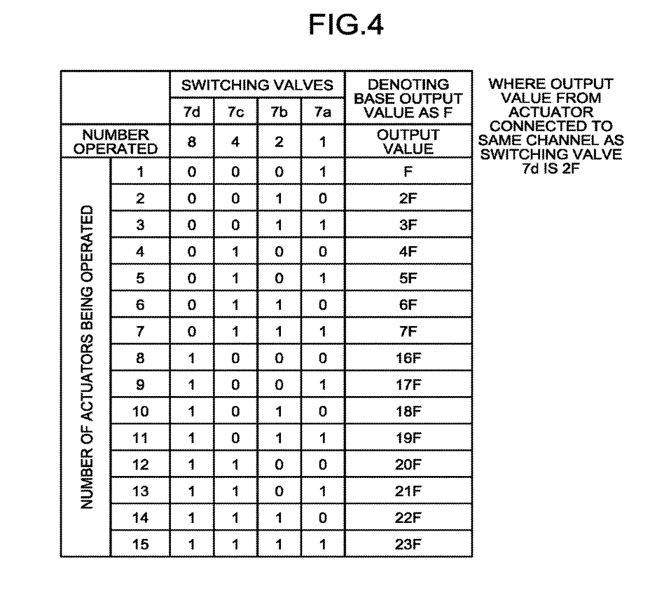

The table in FIG. 4 lists the numbers of the actuator elements driven by combinations of the ON state and the OFF state of the switching valves 7a to 7d, and their respective output values.

As shown in the table in FIG. 4, the output value increases sharply after the switching valve 7d is placed in the ON state and the fluid supply to the channel member 24 starts. The output value of the actuator element group 400 can be changed nonlinearly by changing the command value to the switching valves 7 from (0001) to (1111).

As in the first embodiment, because the fluid supply is controlled for each of the actuator unit 40 using the switching valves 7, it is not necessary to change the diameters of all of the actuator elements connected to the channel members 2. The actuator unit 40 can attain the same effects as long as it includes at least one actuator element having a different diameter.

When the lengths of and the sleeve-winding angles of the actuator elements are the same, an output value that is N times the base output value can be obtained by setting the diameter of the actuator element to √N times larger.

When the fluid flows into the actuator elements at the same flow rate, the response speed of the actuator element 4 changes depending on the diameter size. Thus, to achieve a quick movement, the actuator elements with a smaller diameter are driven while to achieve a higher-load movement at a slower response speed, the actuator elements with a larger diameter are driven, thereby enabling operations considering the response speed. For example, with use of the actuator elements as artificial muscles, they can reproduce operations corresponding to fast muscles and slow muscles of a person. As an example, the artificial muscles can reproduce force or a movement of a hand holding a ball or the like.

With no response speed of the actuator considered, when the output value from two actuator elements is almost the same as the output value of another actuator element with a √2 times larger diameter, the actuator element with the larger diameter can be replaced with the former actuator elements, for example.

Although the numbers of the switching valves 7, the channel members 2, and the actuator units 40 are all set to four as above, the numbers are not limited to four, and may be different numbers. Such a configuration can also attain the same effects as those described above.

This embodiment has described an example in which the diameter of the actuator elements 4A is increased to √2 times larger, however, the diameter f the actuator elements 4A is not limited to √2 times larger, and may be larger than that or smaller than the diameter of the actuator element 4.

### Third Embodiment

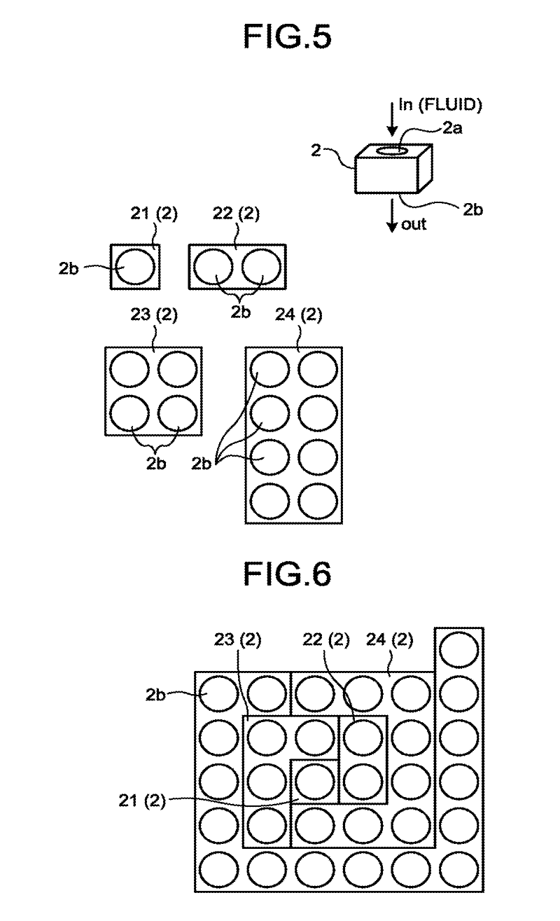

An actuator according to a third embodiment will now be explained with reference to FIGS. 5 to 12.

The third embodiment concerns the arrangement of the channel members 2, and the rest of the configuration is the same as that in the first embodiment.

As described earlier, each of the actuator units 40 includes the actuator elements 4 that are connected to the second ports 2b of the corresponding channel member 2. The actuator units 40 form the actuator element group 400.

To form the actuator element group 400, the channel members 2 are preferably arranged efficiently in terms of space or formed integrally.

FIG. 5 illustrates multiple channel members 2 (21 to 24) each of which has a cuboid or cube shape. FIG. 5 illustrates the channel members 2 viewed from the second ports 2b. FIG. 5 also shows a perspective view of the channel member 22 as an example.

The channel member 22 as a cuboid or cube includes a first port 2a on one face, and the second port(s) 2b on another face opposite the one face. When the number of the channel members 2 is n, the number of the second ports of each of the channel members 2 is 2ⁱ (where i is an integer equal to or more than 0 and equal to or less than n-1), and is different from the others. As mentioned earlier, the channel extending from the first port of the channel member 2 is branched at a midway point and connected to all of the second ports.

The channel member 2 with a cuboid or a cube shape can be placed adjacent to one another, efficiently utilizing space, to form the actuator element group. For example, the channel members 2 are arranged adjacent to one another, with the faces on which no first port or second port is disposed contacting each other, and the faces may partially or entirely contact each other.

FIG. 6 illustrates an example of the arrangement of the channel members 2 (21 to 24) in a spiral form. FIG. 6 is a view of the channel members viewed from the second port 2b.

The channel members 2 with smaller numbers of the second ports 2b are disposed nearer to the center, and those with larger numbers of the second ports 2b are spirally arranged outward from the center. Preferably, the channel members 2 have a polygonal columnar shape and are arranged with no gap. Each of the channel members 2 includes the first port 2a on the bottom face and the second port(s) 2b on the face opposite the bottom face. When the number of the channel members 2 is n, the number of the second ports 2b of the channel member 2 is 2ⁱ (where i is an integer equal to or more than 0 and equal to or less than n-1), and the numbers of the second ports 2b are different among the channel members 2. By designing the shape of the channel members 2 for such a spiral arrangement, the channel members 2 can be efficiently arranged in the space to form the channel component 3.

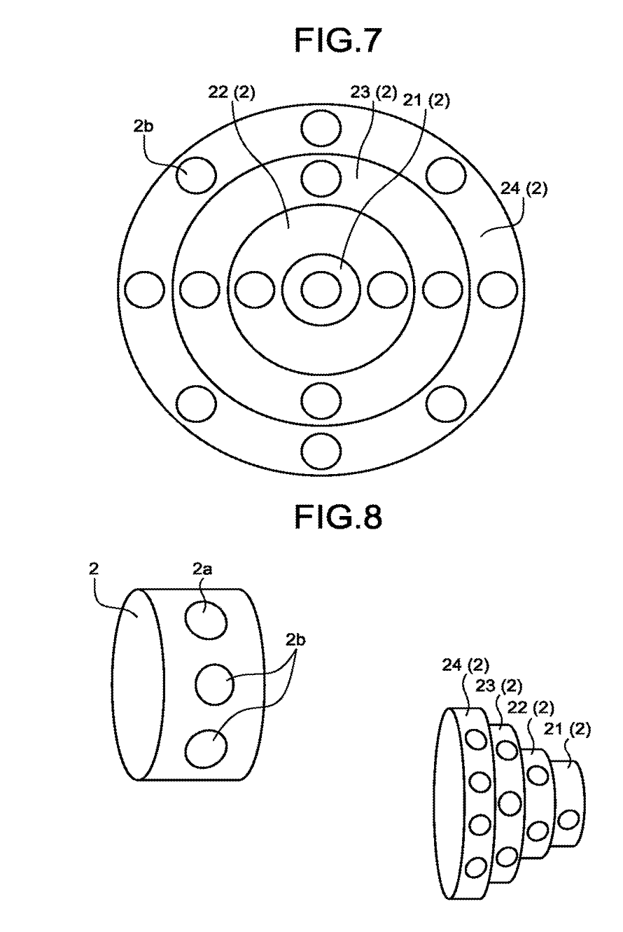

FIG. 7 shows an example of the arrangement of the channel members to 2(21 to 24) in a ring-like form. FIG. 7 illustrates the channel members viewed from the second port 2b. As in FIG. 6, the channel member 2 having one second port 2b is disposed at the center, and the channel members 2 with larger numbers of the second ports 2b are disposed in order outward from the center. The channel member 2 with one second port has a cylindrical shape. The other channel members 2 have ring-like shapes, and are arranged outside the cylindrical shape. Each of the channel members 2 includes the first port 2a on the bottom face and the second port(s) 2b on the face opposite the bottom face. When the number of the channel members 2 is n, the number of the second ports 2b of the channel member 2 is 2ⁱ (where i is an integer equal to or more than 0 and equal to or less than n−1), and the numbers of the second ports are different among the channel members 2. Preferably, the second ports 2b are arranged at an equal interval on the channel members 2 having a ring-like shape.

To form the channel component 3 by arranging the channel members 2 close to one another, the channel component 3 can have a cylindrical shape.

FIG. 8 illustrates an example of the channel members 2 (21 to 24) have a cylindrical shape, including the first port 2a and the second port(s) 2b on the side faces. The channel members 2 are stacked on tops of one another. With this configuration, when formed of the channel members 2 arranged adjacent to one another, the channel component 3 can be prevented from increasing in size two-dimensionally as the number of the second ports 2b increases.

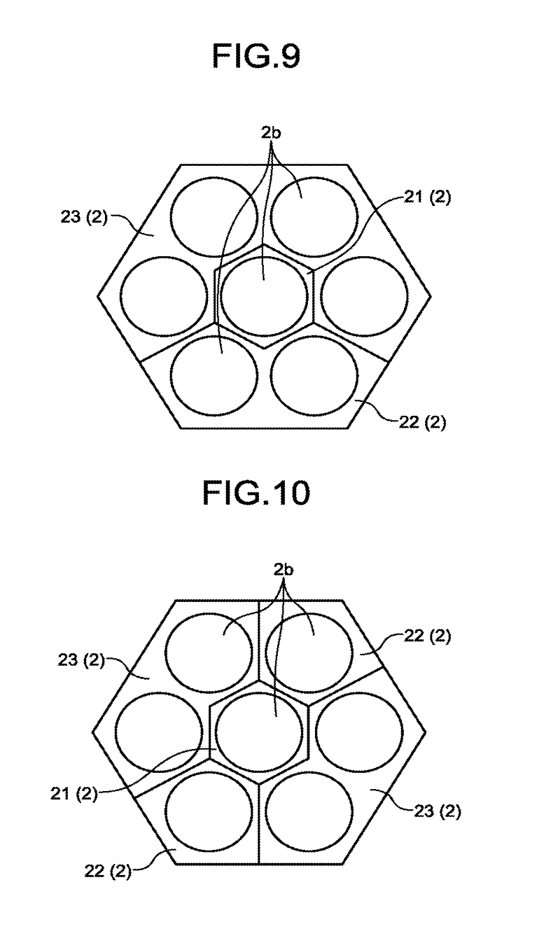

FIG. 9 illustrates an example of the most compact channel component when the number of the channel members 2 (21 to 23) is three (having one, two, and four second ports, respectively). The respective channel members 2 are shaped appropriately for close arrangement, to form the channel component 3 having a hexagonal columnar shape.

As an exemplary arrangement of the channel members 2, the channel member 21 having one second port 2b is arranged at the center and has a hexagonal columnar shape, and the channel member 22 with two second ports 2b and the channel members 23 with four second port 2b are then arranged around the channel member 21. The channel members corresponding to the second bit and the third bit have a shape of joined pentagonal columns. The channel member 22 has a shape of two joined pentagonal columns, and the channel member 23 has a shape of four joined pentagonal columns. The channel component 3 of a hexagonal columnar shape can be formed by arranging the three channel members adjacent to one another. The channel component 3 of a hexagonal columnar shape has three first ports 2a and seven second ports 2b.

With such an arrangement of the second ports 2b, connecting two neighboring second ports 2b form an equilateral triangle, which achieves the tightest tiling. Furthermore, by the hexagonal columnar channel components 3, efficient spatial arrangement is feasible.

FIG. 10 illustrates a modification of the channel component 3 illustrated in FIG. 9, and shows an example of separate arrangement of the second ports 2b on the channel members 22 and those on the channel members 23. In other words, the channel member 22 is divided into two to include one second port, and place the channel member 21 therebetween. The channel member 23 is also divided into two to include two second ports and place the channel member 21 therebetween. In the channel members 23, for exemplary arrangement of the channel members 22, 23, the first port side may be connected while the second port side is separated in unit of two ports.

With the center of the channel component 3 set to the axis, the output value of the actuator unit can be prevented from decentering of the output value about the axis, when supplied with the fluid.

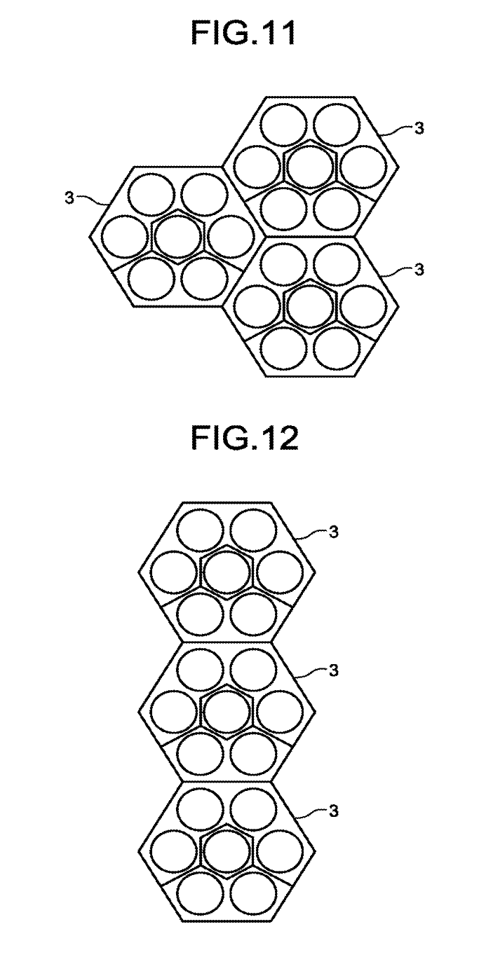

FIG. 11 illustrates an example in which three channel components 3 as illustrated in FIG. 9 or 10 are arranged adjacent to one another. The channel components 3 are arranged in such a manner that the connected centers of the channel components 3 form a triangle. The actuator elements are connected to 21 second ports 2b, respectively. By the tightest tiling of the channel components 3 as described above, the actuator element group can be tightly formed to be able to generate a high output value at one point. Although three channel components 3 are described by way of example, a larger number of the channel components 3 may be provided. A larger number of the channel components 3 can increase the output values of the actuator elements linearly or nonlinearly.

FIG. 12 illustrates an example of serial arrangement of the channel components 3 as illustrated in FIG. 9 or 10 adjacent to one another. The channel components 3 are arranged in such a manner that the connected centers of the channel components 3 form a straight line. This arrangement is effective when an object is intended to be driven in a translational direction with respect to the array of the channel components 3. The object can also be driven at certain angle by differentiating the output values of the respective channel components 3 to the actuator element groups 400. Furthermore, the actuator element group 400 including an actuator element 4 with a different diameter can sharply and nonlinearly change the output value.

The channel components 3 illustrated in FIGS. 5 to 12 may be bonded with the channel members 2 using adhesive agent, for example. Any adhesive agent may be used as long as the channel members 2 can be adhered stably.

Alternatively, the channel members 2 may be provided with recesses and protrusions to fit into one another.

Alternatively, the channel components 3 according to the embodiment may be integrally formed with a mold, for example. Thus, the channel members 2 are integrated, which corresponds to a channel block as described later.

The material of the channel members 2 and the channel components 3 may be a resin material, or a metal material such as aluminum.

The arrangement of the channel members 2 of the present embodiment also enables efficient spatial arrangement of the actuator unit.

### Fourth Embodiment

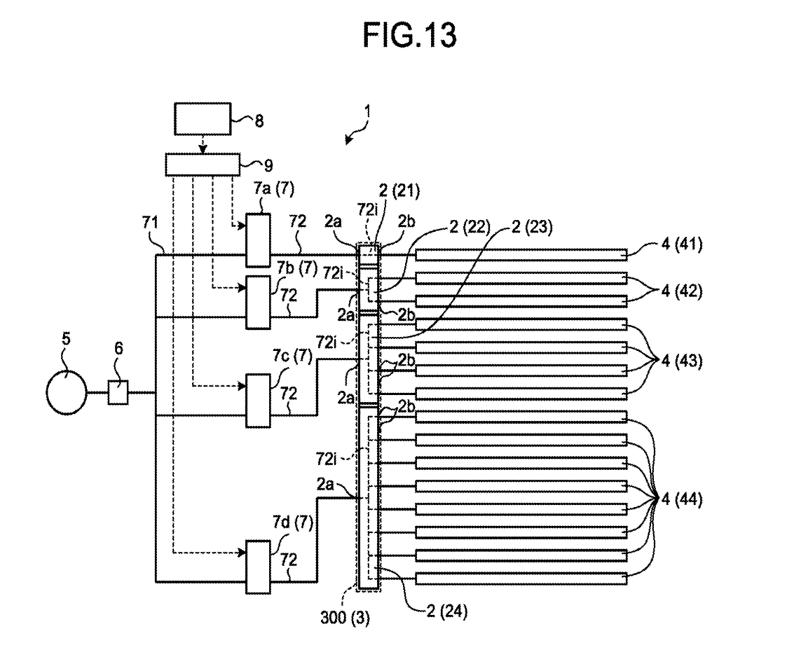

An actuator according to a fourth embodiment will now be explained with reference to FIG. 13.

As illustrated in FIG. 13, the channel members 2 are integrated as one unit to form one channel block 300. The actuator elements 4 of the actuator units 41 to 44 are all connected to the second ports 2b of the channel block 300, respectively. The channel block 300 includes channels 72i corresponding to the actuator units 41 to 44. Each of the channels 72i extends from the first port 2a of each actuator unit, is branched out and connected to the second ports 2b. The channel block 300 is an example of the channel components 3. The rest of the configuration of the actuator is toe same as that in the first embodiment.

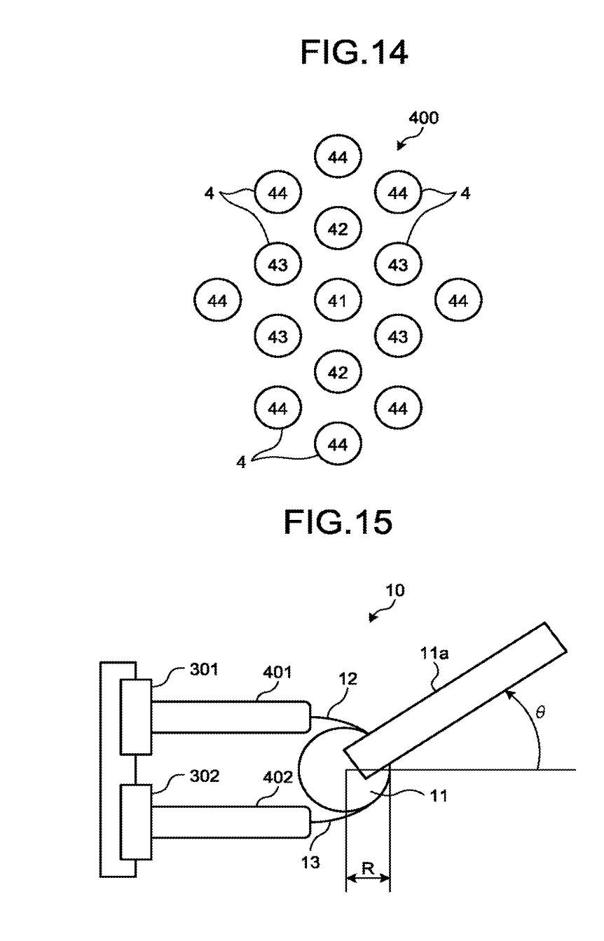

FIG. 14 illustrates the arrangement of the actuator element group 400 of the actuator elements 4 connected to the channel block 300, as viewed from the axial direction of the actuator elements 4. The actuator elements 4 are arranged at the vertexes of unit equilateral triangles most tightly arranged in a virtual plane perpendicular to the axial direction of the actuator elements 4. The numbers in circles represent the actuator units 41 to 44 to which the actuator element 4 belongs. FIG. 14 illustrates an example of the tightest arrangement of the actuator elements 4, however, the actuator elements 4 may also be arranged at the vertexes of unit squares or rectangles, or arranged annularly, as mentioned earlier. As long as the actuator element group 400 can be arranged efficiently in the channel block, the actuator elements 4 may be arranged arbitrarily.

According to the present embodiment, because of the integrated channel members 2, the size or the weight of the actuator can be reduced and the number of parts are reduced, which leads to cost reduction, for example.

### Fifth Embodiment

An actuator system 10 according to e fifth embodiment will now be explained with reference to FIG. 15.

In the actuator system 10 according to the present embodiment, two channel blocks 301 and 302 according to any one of the first to fourth embodiments are arranged side by side, and the actuator elements 4 are connected at one end to the respective second ports 2b in the channel blocks 301 and 302, forming actuator element groups 401 and 402. The actuator element groups 401 and 402 are arranged in parallel in counterbalance.

As illustrated in FIG. 15, a cylindrical rotational element 11 that is a driver of the actuator system 10 is interposed between the actuator element groups 401 and 402. The rotational element 11 has a shaft at the center to rotate about the shaft. A rod 11a is attached to the rotational element 11. The other ends of the actuator element groups 401 and 402 are bundled to be connected at their tips to wire 12 and a wire 13, respectively. These wires 12, 13 are then connected to the circumference of the rotational element 11. The wires 12, 13 are used as connections between the actuator element groups 401, 402 and the rotational element 11. Preferably, the actuator element groups 401, 402 do not become slack, with the wires 12, 13 connected to the rotational element 11.

A first driving method of the actuator system 10 according to the embodiment will now be explained.

Herein the numbers and the diameters of the actuator element groups 401 and 402 are the same, the pressure of the fluid supply to the actuator element group 401 is denoted by P1, the pressure of the fluid supply to the actuator element group 402 is denoted by P2, and the OH/OFF command values to the switching valves 7 are set to the same value, by way of example.

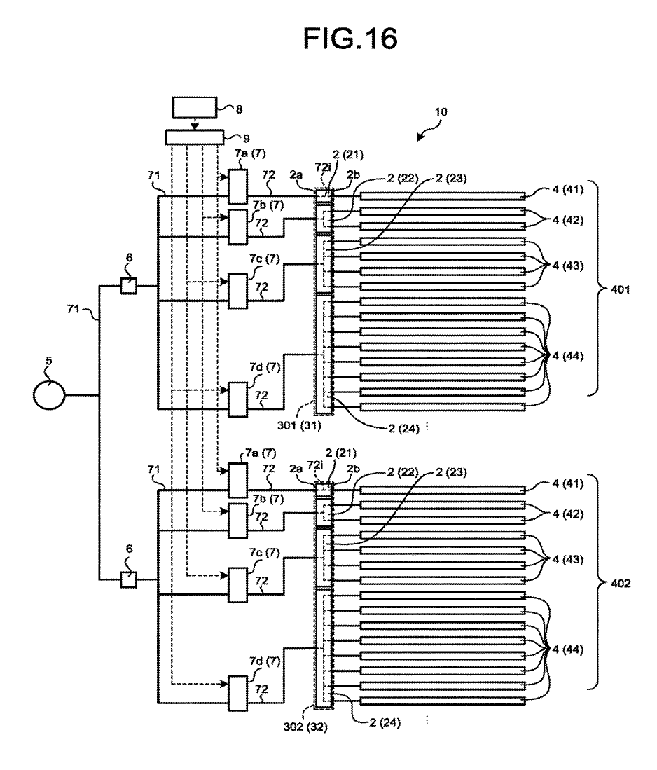

FIG. 16 illustrates a configuration of a fluid supply part in the first driving method. In this driving method, two pressure control valves 6 are disposed to generate the pressures P1 and P2. To each of these pressure control valves 6, multiple switching valves 7 are connected. The switching valves 7 may be three-way solenoid valves. As illustrated in FIG. 16, four switching valves 7a to 7d are connected to each of the pressure control valves 6. The channel members 21 to 24 are connected to the switching valves 7a to 7d, respectively. The channel members 21 to 24 form the corresponding channel block 301, 302. The channel blocks 301 and 302 may also be channel components 31 and 32, respectively. The actuator element groups 401 and 402 are connected to the two channel blocks, respectively.

In this example, because the numbers m of operating actuator elements in the actuator element groups 401 and 402 are the same (the ratio of the numbers of the actuator elements in operation is one to one), a rotation angle θ of the rotational element 11 is controlled by the pressures P1, P2 from the two pressure control valves 6.

When the pressures are P1>P2, the rotational element 11 and the rod 11a are driven counterclockwise. When P1<P2, the rotational element 1 and the rod 11a are driven clockwise.

In the first driving method, the rotation angle of the rotational element 11 can be controlled by controlling the pressures of the two pressure control valves 6.

Furthermore, by changing the number m of the operating actuator elements, the joint stiffness of the rotational element 11 can be changed easily. Specifically, the joint stiffness thereof will be a product of the joint stiffness of one actuator element multiplied by m.

For operating the actuator system 10 to approach an object with unknown stiffness and move the object, as an example, during the angle control, the number of actuator elements to operate are decreased for the purpose of implementing a quick motion to lower the stiffness of the rotational element and hit the object softly. The stiffness of the rotational element is then increased to a level suitable for the object while the number of operating actuator elements are gradually increased. By such a movement, even softer objects can be transported.

A second driving method of the actuator system 10 according to the present embodiment will now be explained. In this method, the ratio of the operating actuator elements between the actuator element group 401 and the actuator element group 402 is changed. Herein, the numbers of the actuator elements in the actuator element group 401 and those in the actuator element group 402 are set to the same number (N), and the pressure of the fluid supply to the actuator element groups 401, 402 is denoted as 23. Where the number of the operating actuator elements in the actuator element group 401 is m and the number of the operating actuator elements in the actuator element group 402 is n, the angle of the rotational element 11 can be controlled in accordance with the ratio of the number m of the operating actuator elements in the actuator element group 401 to the number n of the operating actuator elements in the actuator element group 402. When m>n, the rotational element 11 and the rod 11a are driven counterclockwise. When m<n, the rotational element 11 and the rod 11a are driven clockwise. Specifically, the angle θ of the rotational element 11 can be expressed by the following Equation (2) from the number m of the operating actuator elements in the actuator element group 401, and the number n of the operating actuator elements in the actuator element group 402.

$$θ = α \times \frac{m - n}{m + n} \qquad ( 2 )$$

where α is a constant determined based on the radius R of the rotational shaft, the characteristics of the actuator elements, and the supplied pressure P3. The joint stiffness β of one actuator element supplied with the pressure P3 can be represented by (m+n)×β. Aiming for setting the joint stiffness to Km and the angle to θm, the numbers m and n of actuator elements can be determined by following Equations (3) and (4).

$$\begin{matrix}m = \frac{{θ}_{m} + α}{2 βα} {K}_{m} & ( 3 ) \\ n = \frac{α - {θ}_{m}}{2 βα} {K}_{m} & ( 4 )\end{matrix}$$

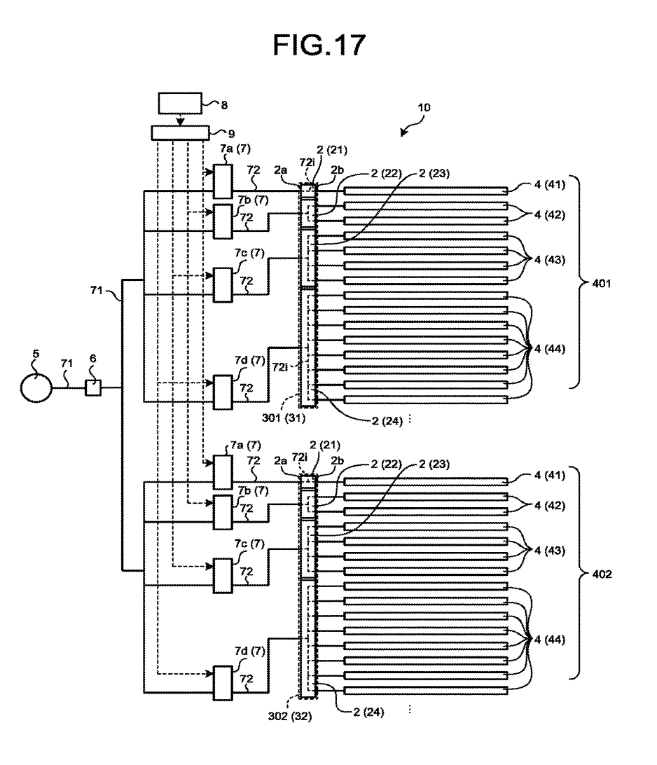

For example, to set the angle θm to α/5 and the stiffness Km to 5β, the number m is set to three and the number n is set to two. To change the angle θm to 3α/5 therefrom, the number m is set to four and the number n is set to one. To change the angle θm to α/5 and the joint stiffness Km to 10β, the number m is set to six and the number n is set to four. Thus, the joint stiffness and the joint angle can be set from the numbers m and n of operating actuator elements. This driving method is for the configuration Illustrated in FIG. 17. This configuration is the same as that illustrated in FIG. 16, except for the number of the pressure control valve 6, which is one. While FIG. 16 shows two pressure control valves 6, and in FIG. 17 only one pressure control valve 6 is used to commonly supply the pressure P3 to the actuator element groups 401, 402. Thereby, the number of pressure control valves can be reduced. According to this driving method, however, the numbers m and n may not result in an integer depending on the joint stiffness Km and the angle θm.

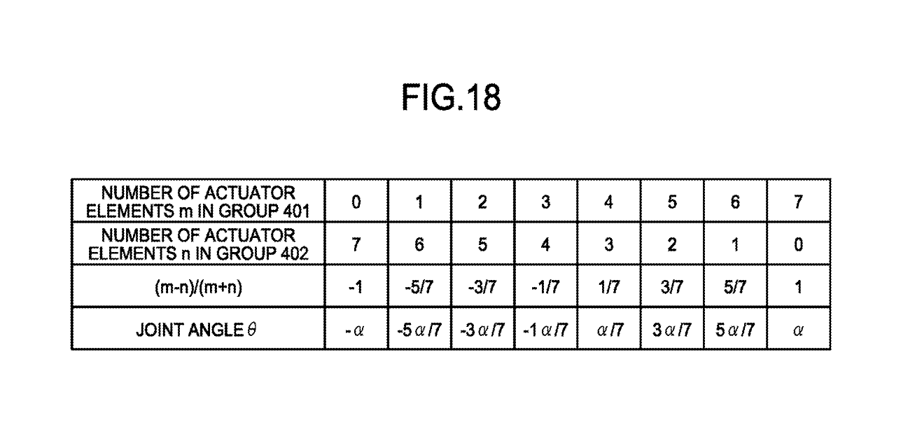

In view of this, the numbers m+n may be set to maintain a constant sum of the numbers m and n of the operating actuator elements in the actuator element group 401 and the actuator element group 402. Thereby, the angle can be expressed by Equation (2). When the total number of the actuator elements in the actuator element group 401 and the actuator element group 402 is seven, for example, the driving angle can be changed stepwise, as illustrated in FIG. 18.

In this case, since the stiffness of the rotational element 11 does not depend on the ratio of the operating actuator elements, the supplied pressure P is changed to change the joint stiffness of the rotational element 11.

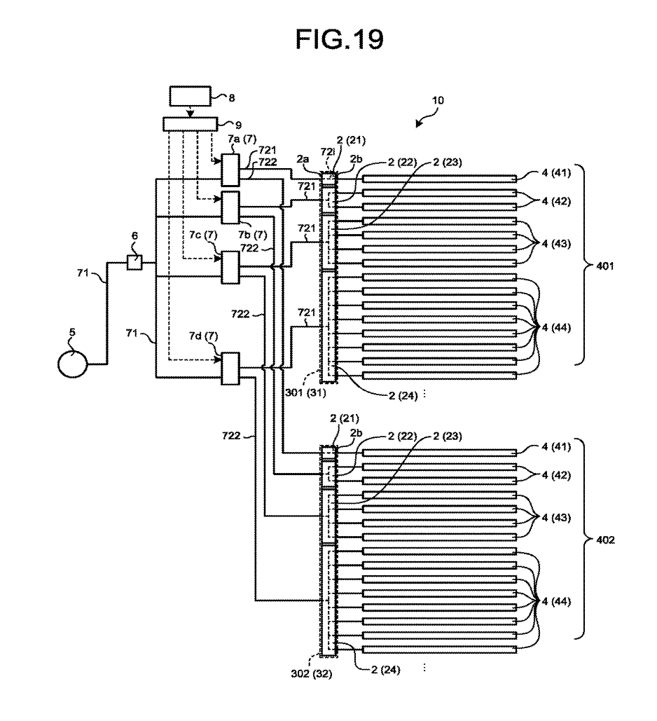

FIG. 19 illustrates a configuration of the fluid supply part in a third driving method. As illustrated in FIG. 19, the number of the pressure control valves 6 is one. The switching valves 7a to 7d are connected to the pressure control valve 6.

Preferably, each of the switching valves 7a to 7d is a five-way solenoid valve provided with five ports (not illustrated),i.e., a supply port, a first actuator port, a second actuator port, a first discharge port, and a second discharge port, for example. In this case, the supply port of the five-way solenoid valve is connected to a channel 71 which is pressure-controlled. The first actuator port is connected to a channel 721 that is connected to the actuator units 41 to 44 of the actuator element group 401. The actuator port 2 is connected to a channel 722 that is connected to the actuator units 41 to 44 of the actuator element group 402. The first discharge ports and the second discharge ports of each of the switching valves 7a to 7d are connected to a drain. Each of the switching valves 7a to 7d is switched between a first state and a second state in response to an electric signal. In the first state the actuator port becomes connected with the supply port and disconnected from discharge port, and the actuator port 2 becomes connected with the discharge port 2 and disconnected from the supply port. In the second state the actuator port becomes connected with the discharge port and disconnected from the supply port, and the second actuator port becomes connected with the supply port and disconnected from second discharge port. In other words, each of the switching valves 7a to 7d is switched independently between the first state and the second state.

The flow of the fluid in the third driving method will now be explained in detail, focusing on the switching valve 7a.

In the first state, the actuator unit 41 of the actuator element group 401 is connected to the channel 71 pressure-controlled by the pressure control valve 6, via the channel 721 and the switching valve 7a. Thus, the fluid is supplied to the actuator unit 41 of the actuator element group 401. The channel 722 connected to the actuator unit 41 of the actuator element group 402 is connected to the drain of the switching valve 7a, and disconnected from the channel 71. No fluid is thus supplied into the actuator unit 41 of the actuator element group 402.

In the second state, the actuator unit 41 of the actuator element group 402 is connected to the channel 71 pressure-controlled by the pressure control valve 6, via the channel 722 and switching valve 7a. The fluid is thus supplied into the actuator unit 41 of the actuator element group 402. The channel 721 connected to the actuator unit 41 of the actuator element group 401 is connected to the drain, and disconnected from the channel 71. No fluid is thus supplied into the actuator unit 41 of the actuator element group 401.

In other words, by switching the switching valve between the first state and the second state, the fluid is supplied into one of the actuator units 41 of the actuator element groups 401 and 402.

Thus, by switching each one of the switching valves 7i to 7d between the first state and the second state, supply and non-supply of the to the actuator units 41 to 44 of the actuator element group 401 or 402, that is, the operating state and non-operating state of the actuator elements can be switched.

As illustrated in FIG. 19, when the numbers and the configurations (such as the diameter of the actuator elements) of the actuator units and the actuator elements in the actuator element groups 401 and 402 are the same, the joint stiffness and the angle can be changed while satisfying m+n=N.

According to the third driving method, the number of the pressure control valves 6 can be reduced to one, and the number of solenoid valves can be cut down to a half, which achieves cost reduction.

Furthermore, by changing the ratio of the operating actuator elements in the actuator element group 401 and those in the actuator element group 402, the rotation angle of the rotational element 11 car be controlled

Furthermore, by changing the pressure of the pressure control valve 6, the stiffness of the rotational element can be changed.

In the actuator systems 10 illustrated in FIGS. 16, 17, and 19, the configurations and the numbers of the actuator units and the actuator elements in the actuator element groups 401 and 402 are the same, however, they may be differently set between the actuator element groups 401 and 402. The number of the actuator element groups may be two or more in place of two in the above embodiments. The above embodiments have described the example of the four channel members included in the channel block, however, should not be limited to such example. Two or more actuator systems 10 according to the present embodiment including the actuator element groups 401 and 402 arranged in counterbalance may be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. The configurations and the shapes disclosed in the embodiments may also be partially replaced with one another. Specifications such as configurations and shapes (e.g., structures, types, directions, shapes, sizes, lengths, widths, thickness, heights, angles, numbers, arrangements, positions, and materials) may be changed as appropriate.

For example, actuators or actuator systems including actuator units which generate output different output values, or actuator units including different numbers of actuator elements (numbers of outlets provided in the channel components) can generate various different output values by changing the number or the combination of such output values or actuator elements. Because of this, the number of switching valves can be reduced. In other words, the present invention is not limited to the configuration in which each of the actuator units outputs a value that is a power of two of the base output value, or in which the number of the actuator elements is a power of two, as long as the actuator includes actuator units which generate different output values, or actuator units having different numbers of actuator elements.

Furthermore, the actuator and the actuator system according to the embodiments can be applied to devices other than artificial muscle. The actuator element may be any actuator element that is not for artificial muscles. Two or more actuators and actuator systems according to the embodiments may also be provided. The output value may represent any force other than the tensile force (contraction), and may represent any physical quantity in a dimension other than the force. Furthermore, the actuator according to the embodiments can also be used with a liquid or any substance having fluidity, as well as gas, for example.

1. An actuator comprising a plurality of channel members each having at least one first port into which fluid flows and at least one second port from which the fluid flows out, wherein
at least one of the channel members includes a different number of second ports from a number of first ports, and
the channel members are joined with each other to form at least one channel component.

2. The actuator according to claim 1, wherein, when the number of the channel members of the channel component is n where n is an integer equal to or more than two, the number of the second ports of an n^{th} channel member is 2ⁱ where i is an integer equal to or more than 0 and equal to or less than n-1.

3. The actuator according to claim 1, further comprising a plurality of actuator units configured to operate when supplied with fluid from the channel members, wherein
each of the actuator units includes a plurality of actuator elements connected to the respective second ports.

4. The actuator according to claim 3, wherein the actuator elements of at least one of the actuator units include at least one actuator element with a different diameter.

5. The actuator according to claim 3, wherein at least one of the actuator units operates by a fluid supply to output a different output value.

6. The actuator according to claim 3, wherein
the actuator elements are configured to operate by the fluid supply, and
a base output value of the actuator elements is different from an output value from the actuator element with a different diameter.

7. The actuator according to claim 3, wherein
the actuator units are configured to contract in response to the fluid supply,
contraction amounts of the actuator units when supplied with the fluid are the same, and
the output value represents a tensile force generated from the contraction of the actuator units.

8. The actuator according to claim 1, wherein each of the channel members has a cuboid or cube shape.

9. The actuator according to claim 1, wherein the channel members are spirally arranged to form the channel component.

10. The actuator according to claim 1, wherein each of the channel members has a cylindrical or ring-like shape, and
one of the channel members having the cylindrical shape is placed at a center and the channel members having the ring-like shape are arranged around the one cylindrical-shape channel member to form the channel component.

11. The actuator according to claim 1, wherein each of the channel members has a columnar or polygonal columnar shape, and
the channel members having the columnar or polygonal columnar shape are stacked on top of each other to form the channel component.

12. The actuator according to claim 1, wherein the channel members are arranged to form at least one channel component having a hexagonal-columnar shape.

13. The actuator according to claim 1, further comprising:
a fluid supply source that supplies fluid;
a control valve configured to control a flow rate of the fluid from the fluid supply source; and
a plurality of switching valves configured to switch supply and non-supply of the fluid from the control valve to each of the channel members.

14. An actuator system comprising:
the actuators according to claim 3;
a fluid supply source that supplies fluid;
a control valve configured to control a flow rate of the fluid from the fluid supply source; and
a plurality of switching valves configured to switch supply and non-supply of the fluid from the control valve to the channel members.

15. A channel component for use in an actuator that operates when supplied with fluid, the channel component comprising
a plurality of channel members each including a first port from which the fluid flows and a second port from which the fluid flows out, wherein
at least one of the channel members includes a different number of second ports from a number of first ports, and
the channel members are joined with each other.

16. The channel component according to according to claim 15, wherein, when the number of the channel members is n where n is an integer equal to or more than 2, the number of the second ports of an n^{th} channel member is 2ⁱ where i is an integer equal to or more than 0 and equal to or less than n-1.

17. The channel component according to claim 15, wherein each of the channel members has a cuboid or cube shape.

18. The channel component according to claim 15, wherein the channel members are spirally arranged.

19. The channel component according to claim 15, wherein each of the channel members has a cylindrical or ring-like shape, and one of the channel members having the cylindrical shape is placed at a center and the channel members having the ring-like shape are concentrically arranged around the one cylindrical-shape channel member.
